(19) United States
(12) Patent Application Publication
(10) Pub. No.: US 2009/0015083 A1
(43) Pub. Date: Jan. 15, 2009

(54) Shaft grounding thread structure of an electric motor

(76) Inventor: Li-Min Hsieh, YangMei Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/822,882

(22) Filed: Jul. 11, 2007

(51) Int. Cl. H02K 11/00; H02K 13/00

(52) U.S. Cl. 310/66; 310/219; 310/90; 310/71; 310/239

(57) ABSTRACT

Thread structure for the shaft grounding of an electric motor having a thin thread formed on the surface of the slip ring or the shaft to replace the conventional face contact with the “linear contact” between the surface of the carbon brush and the thread head. During the rotation, the development of friction heat and the oxidation film will be substantially eliminated. Furthermore, the effect of spiral conveyor belt is created when the thread rotates. This can remove the toner, copper powder, etc. produced by friction acting on the surface of the carbon brush and keep a permanent cleanness of the surface of the carbon brush. In this way, a stable contact resistance between the shaft (or the slip ring) and the carbon brush can be maintained and a long-term test shows that the wear of the carbon brush will be further reduced before improvement.

### BACKGROUND OF THE INVENTION

1. Field of the Invention

The invention relates to a shaft grounding thread structure of an electric motor, and more particularly to a shaft grounding structure in which a thin thread is formed on the surface of a slip ring or the shaft to replace the conventional face contact by the “linear contact” between the surface of the carbon brush and the thread peak.

2. Description of the Related Art

As shown in FIG. 1, a conventional electric motor consists of a housing 11, a stator 12, a rotor 13, a rotary drivable shaft 14 as well as a ball bearing 15 for supporting the shaft. As a result of the unbalance of magnetic circuit, external voltage (such as the PWM-voltage of the AC motor frequency inverter or DC motor speed controller), shaft magnetizing effect and the electrostatic induction (such as the electrostatic charging arising between pulley 16 and the belt 161) may generate a shaft voltage during the operation of this type of electric motor 10.

This voltage will cause so-called shaft current between the inner and outer rings 152 of the ball bearing 15, which creates electric arc by flowing through contact points on the rolling balls 151 and the inner and outer rings 152. Due to the corrosion of the electric arc, the crater-like corrosion spots and the corrosion spots stemming from washboard effect will be formed on the surface of the rolling way of the inner and outer rings 152, which result in noise and bearing failure.

Currently, two methods can be applied to solve the above-mentioned problem: shaft insulation or shaft grounding carbon brush. Because of the simplicity and low cost, the shaft grounding carbon brush is frequently employed in normal electric motors, whose structure is shown in FIG. 1. A carbon brush 17 and a compression spring at the rear end thereof are employed to ensure a close contact of the front end of the carbon brush 17 to the slip ring 141 at the tail of the shaft or the shaft surface. In this way, the by-pass of the inner and outer rings 152 of the bearing takes place. Since the contact resistance is far less than the resistance between the inner and outer rings 152, the shaft current will run through the tail of the shaft 14 (or the slip ring 141) and the carbon brush 17 to achieve the grounding effect. As a result, the ball bearings 15 are protected so as to extend their service life.

However, a layer of black oxidation film will be formed after some period of application of the shaft grounding carbon brush 17 whose ingredients include oil pollution, dust, copper powder etc. It results in a gradual rise of the contact resistance value. When the contact resistance is bigger than resistance between the inner and outer rings 152 of the bearing 15, most of the shaft current will flow through the bearing 15 and the protecting function of the grounding carbon brush 17 will be lost.

How to eliminate the black oxidation film on the surface of the shaft or the slip ring 141 to maintain a stable contact resistance, is the topic handled in the invention.

### SUMMARY OF THE INVENTION

Therefore, it is a primary object of the present invention to provide a thread structure for the shaft grounding of an electric motor that includes a thin thread is formed on the surface of the slip ring or the shaft to replace the conventional face contact with the “linear contact” between the surface of the carbon brush and the thread head. During the rotation, the development of friction heat and the oxidation film will be substantially eliminated. Furthermore, the effect of spiral conveyor belt will be created when the thread rotates. This can remove the toner, copper powder, etc. produced by friction acting on the surface of the carbon brush and keep a permanent cleanness of the surface of the carbon brush. In this way, a stable contact resistance between the shaft (or the slip ring) and the carbon brush can be maintained and a long-term test shows that the wear of the carbon brush will be further reduced before improvement.

In order to achieve the above-mentioned objects, a shaft grounding thread structure of an electric motor includes:

a) an electric motor having a housing, a rotary driven shaft being mounted within the housing, at least one thin thread structure being formed on the circumferential surface of the tail of this shaft, and

b) a grounding carbon brush device located at one side of the thin thread structure, the grounding carbon brush device being composed of a carbon brush, a hollow positioning body for receiving the carbon brush and a spring mounted within the hollow body, thereby pushing the front surface of the carbon brush against the spring of the thin thread structure.

Based upon the above-mentioned features, the thin thread structure is directly formed on the circumferential surface of the shaft tail. It is also possible that the thin thread structure previously formed on a slip ring, and then this slip ring will be compressed on the shaft tail for the fixing purpose.

The afore-mentioned grounding characteristic realized by a spiral line contact has been successfully used in the shaft grounding application to a treadmill's motor.

### BRIEF DESCRIPTION OF THE FIGURES

FIG. 1 shows a sectional view of a conventional electric motor;

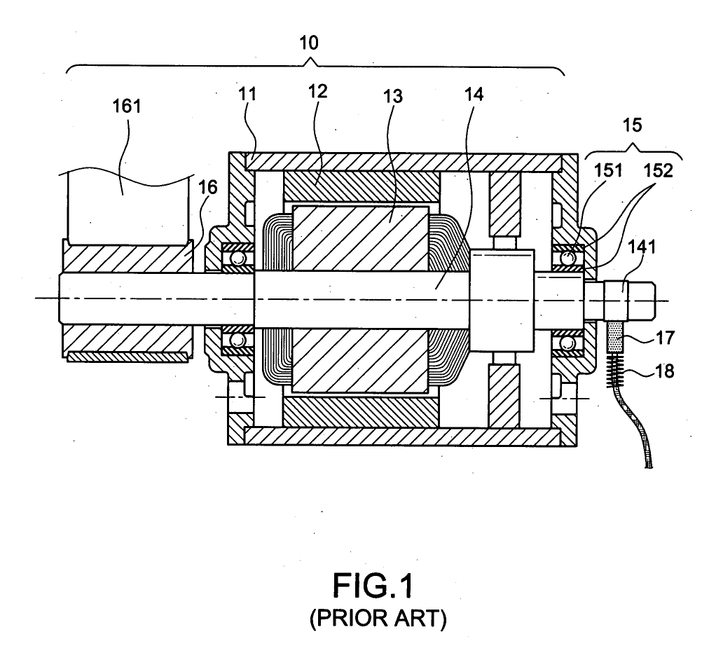

FIG. 2 is an exploded view of a first embodiment according to the invention;

FIG. 3 shows a perspective assembly view of the first embodiment according to the invention;

FIG. 4 shows schematically the main parts of the first embodiment according to the invention;

FIG. 5 is a sectional view taken along line 5-5 in FIG. 4; and

FIG. 6 shows schematically a second embodiment of the invention.

### DETAILED DESCRIPTION OF THE PREFERRED EMBODIMENT

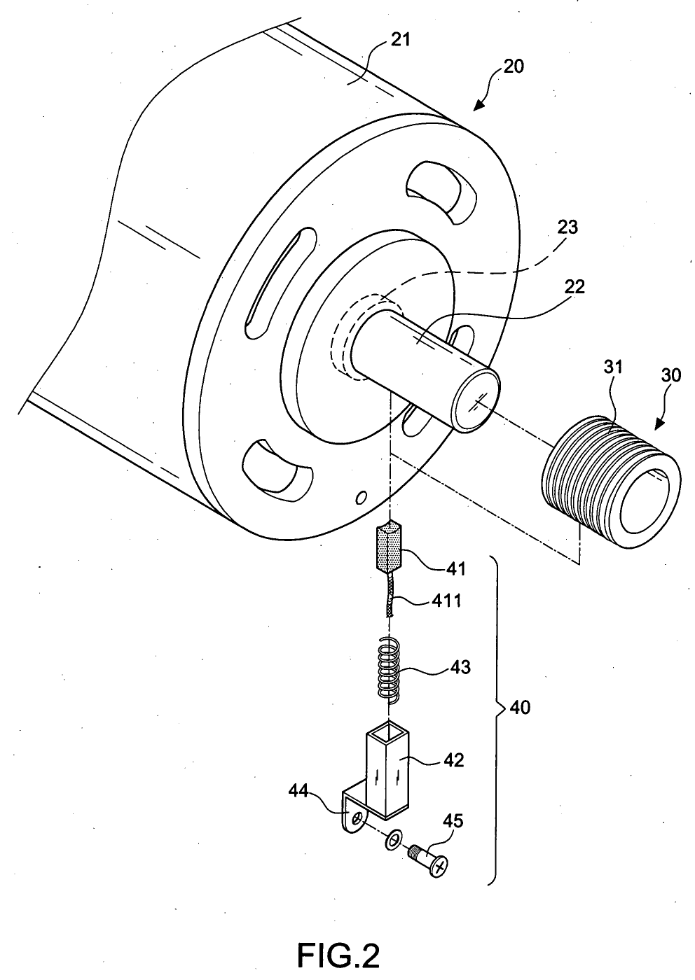

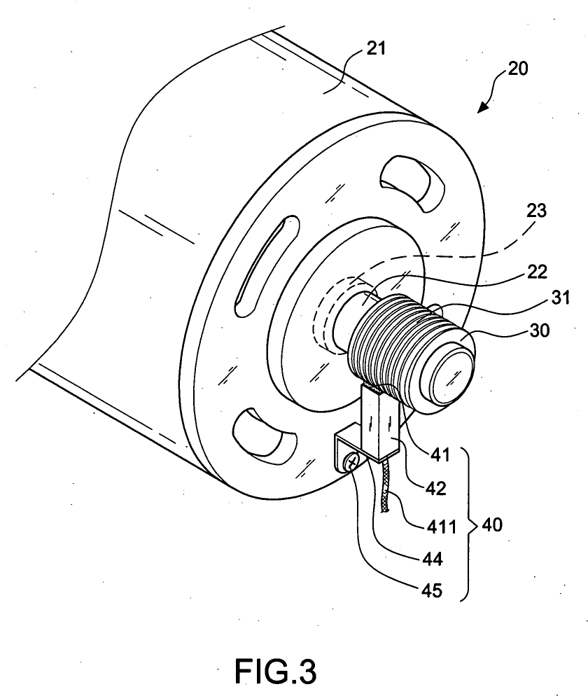

As shown in FIG. 2 and FIG. 3, a first embodiment according to the invention consists of an electric motor 20 and a grounding carbon brush device 40.

The electric motor 20 includes a housing 21. A rotary drivable shaft 22 is disposed within the housing 21 and supported by the ball bearing 23 outside of the housing 21. Since it belongs to the conventional technique of the electric motor, a further description won't be given hereinafter.

It is characterized that the end of the shaft 22 extends through the motor housing 21, on which a slip ring 30 is assembled. A thin thread structure 31 is formed on the circumferential surface in such a way that the surface of the tail of shaft 22 is provided with thin thread structure.

The grounding carbon brush device 40 is located on one side of the thin thread structure 31 and composed of a carbon brush 41, a hollow positioning body 42 for receiving the carbon brush 41 as well as a spring 43 positioned within the hollow body, thereby pushing the front surface of the carbon brush 41 against the spring of the thin thread structure 31. Also, the carbon brush 41 is connected with a grounding wire 411, which can be extended from the bottom of the hollow positioning body 42.

In this application, a fixing plate 44 is positioned at the bottom of the hollow positioning body 42 and is fixed on the housing 21 by a screw 45. Alternatively, the hollow positioning body 42 can be mounted on a machine table (not shown) near the electric motor, instead on the housing 21. However, regardless of fixing position of the hollow positioning body 42, it is aimed to position the carbon brush 41 in place and keep it always in close contact with the thin thread structure 31.

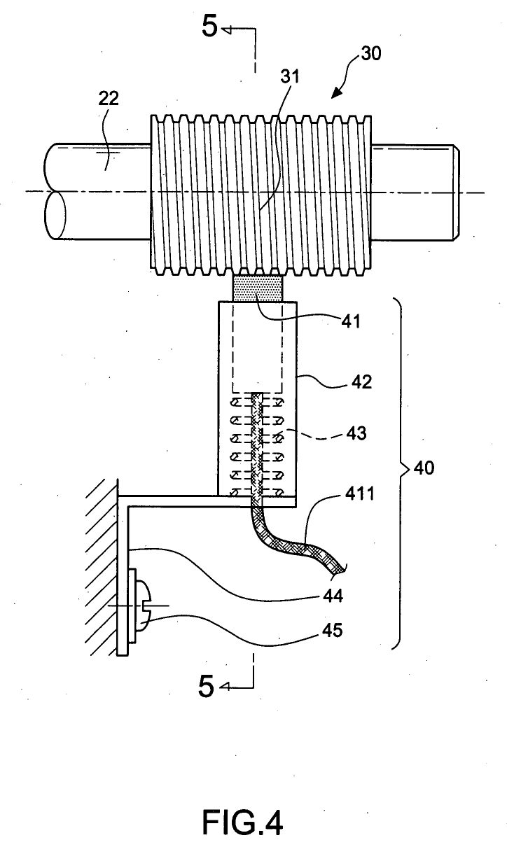

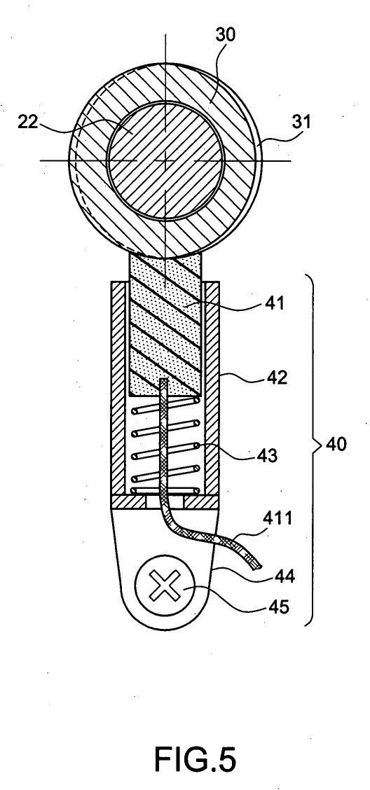

As shown in FIG. 4 and in FIG. 5, the slip ring 30 is formed according to the invention as a thin structure 31 with non-smooth surface to replace the conventional plain contact by linear contact. At first glance, it seems to be contrary the general sense; however, it has been indicted by the inventor with long-period test that the wear degree between carbon brush 41 and thin thread structure 31 is further reduced than that in face contact.

Moreover, it is more important that the development of friction heat and the oxidation film during rotation of slip ring 30 can be substantially reduced by the replacement of face contact with linear contact. Furthermore, the effect of “spiral conveyor belt” will be created by the thin thread structure 31 when rotating, which removes the toner, copper powder etc. produced by friction acting on the surface of the carbon brush 41 and keeps a permanent cleanness of the surface of the carbon brush 41. In this way, a stable contact resistance between the slip ring 30 and the carbon brush 41 can be maintained. With the help of this effect, the shaft current can be smoothly conducted away through the grounding carbon brush device 40, which protects the ball bearing 23 and extends its service life.

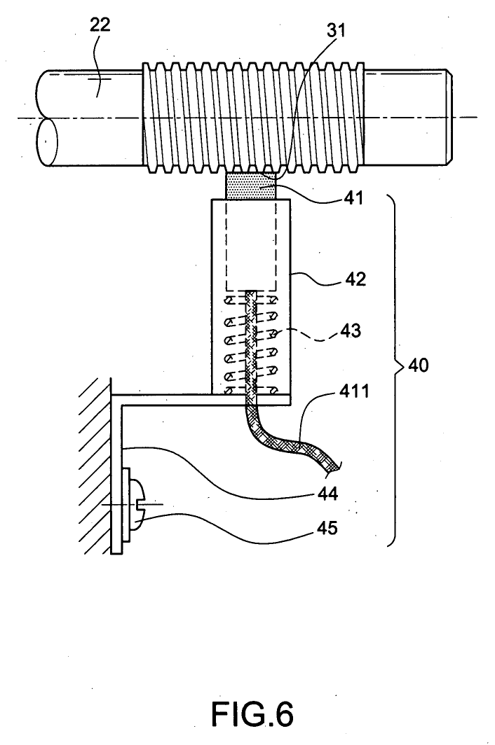

FIG. 6 shows schematically a second embodiment according to the invention, wherein the thin thread structure 31 is formed directly on the circumferential surface of the tail of the shaft 22 and has the identical function as the previous embodiment.

Many changes and modifications in the above-described embodiments of the invention can, of course, be carried out without departing from the scope thereof. Accordingly, to promote the progress in science and the useful arts, the invention is disclosed and is intended to be limited only by the scope of the appended claims.

What is claimed is:

1. A shaft grounding thread structure of an electric motor, comprising:
a) an electric motor having a housing, a rotary driven shaft being mounted within the housing, at least one thin thread structure being formed on the circumferential surface of the tail of this shaft, and
b) a grounding carbon brush device located at one side of the thin thread structure, the grounding carbon brush device being composed of a carbon brush, a hollow positioning body for receiving the carbon brush and a spring mounted within the hollow body, thereby pushing the front surface of the carbon brush against the spring of the thin thread structure.

2. The shaft grounding thread structure of an electric motor as recited in claim 1, wherein the thin thread structure is formed on a slip ring, and then the slip ring is so compressed that it is fixed at the tail of the shaft.

3. The shaft grounding thread structure of an electric motor as recited in claim 1, wherein the thin thread structure is directly formed on the circumferential surface of the tail of the shaft.

4. The shaft grounding thread structure of an electric motor as recited in claim 1, wherein a grounding cable is connected with the tail of the carbon brush.

5. The shaft grounding thread structure of an electric motor as recited in claim 1, wherein a fixing plate is disposed at the bottom of the hollow positioning body,
